(19) United States
(12) Patent Application Publication
(10) Pub. No.: US 2025/0123002 A1
(43) Pub. Date: Apr. 17, 2025

(54) Appliance for heating food and/or for emitting heat to the surroundings

(71) Applicant: HYTING GMBH, Wiesbaden (DE)

(72) Inventor: Tim Hannig, Wiesbaden (DE)

(21) Appl. No.: 18/688,013

(22) PCT Filed: Aug. 30, 2022
(86) PCT No.: PCT/EP2022/073994

§ 371 Date: Feb. 29, 2024

(30) Foreign Application Priority Data
Aug. 30, 2021 (DE) 10 2021 122 410.1

(51) Int. Cl. F24C 3/06; A47J 37/07; C25B 1/04; F23C 13/00; F24C 3/12

(52) U.S. Cl. CPC F24C 3/06; A47J 37/0704; A47J 37/0786; F23C 13/00; F24C 3/122; A47J 2202/00; C25B 1/04; F23C 2900/9901

(57) ABSTRACT

In one aspect, an appliance for heating food, in particular a grill, and/or for emitting heat to the surroundings, in particular a heating appliance, includes at least one provision unit for providing hydrogen and at least one reaction unit for generating heat from the hydrogen. In one implementation, the reaction unit is designed as a catalytic unit for the flameless combustion of the hydrogen having at least one catalyst for catalyzing the hydrogen.

### CROSS-REFERENCE TO RELATED APPLICATIONS

The present application is a U.S. national phase of International Patent Application No. PCT/EP2022/073994, filed Aug. 30, 2021, which, in turn, is based on and claims the right of priority to German Patent Application No. 10 2021 122 410.1, filed Aug. 30, 2021, the disclosures of both of which are hereby incorporated by reference herein in their entirety for all purposes.

### FIELD OF THE INVENTION

The present subject matter relates to an appliance for heating food and/or for emitting heat, in particular thermal radiation and/or a warm air flow, to the surroundings, in particular a grill and/or a radiant heater, the appliance having at least one provision unit for providing hydrogen and at least one reaction unit for generating heat from the hydrogen.

### BACKGROUND OF THE INVENTION

Appliances for heating food, in particular grills, and appliances for emitting heat, in particular thermal radiation and/or a warm air flow, to the surroundings (e.g., radiant heaters) are widely known from the prior art. Frequently, a fossil fuel such as, for example, propane gas, is used to operate appliances of these types. More environmentally friendly alternatives of appliances of these types, which use hydrogen instead, are also known from the prior art.

For example, WO 2011/062513 A1 describes a cooking apparatus, which generates a combustible fuel from a water source using an electrolyzer and burns this combustible fuel in a burner by adding air. The disadvantage thereof is that a water source having water which can be used by the electrolyzer must always be available. In addition, burning the hydrogen as an open flame poses a safety risk. In contrast to fossil fuels, hydrogen burns essentially colorlessly. It is therefore difficult for a user to recognize that the cooking apparatus is being used, as a result of which serious injuries can occur.

Accordingly, there is a need for an appliance that eliminates one or more of the disadvantages known from the prior art. For example, there is a need for an appliance for heating food and/or for emitting heat, in particular thermal radiation and/or a warm air flow, to the surroundings that can ensure safe operation, results in low operating costs and/or can be operated irrespective of location.

### SUMMARY OF THE INVENTION

In various aspects, the present subject matter is directed to an appliance and related methods having the features described and claimed herein.

In one aspect, the present subject matter relates to an appliance for heating food and/or for emitting heat, in particular thermal radiation and/or a warm air flow, to the surroundings, preferably outside and/or inside, the appliance having at least one provision unit for providing hydrogen and at least one reaction unit for generating heat from the hydrogen.

An appliance for heating food can be understood, for example, to be a cooking appliance, a hot plate, a grill and/or an oven, in particular outside and/or inside. An appliance for emitting heat, in particular thermal radiation and/or a warm air flow, to the surroundings can be understood, for example, to be a heating appliance, a radiant heater, a fan heater, a chimney stove, a stationary heater, a patio heater and/or an open fireplace, in particular outside and/or inside. Outside and/or inside should be understood to mean the location of the appliance at which these can be operated. Outside should be understood to mean, for example, the location of the appliance outdoors and/or under open skies. Inside should be understood to mean the location of the appliance in a building, house, tent, boat, motorhome and/or mobile home.

The hydrogen is supplied together with air and oxygen as a reaction gas mixture to the reaction unit. In order to obtain the thermal energy necessary for heating the food and/or for emitting heat, in particular thermal radiation and/or a warm air flow, to the surroundings, the hydrogen reacts with air and/or oxygen in the reaction unit.

According to at least one aspect of the present subject matter, the reaction unit is designed as a catalytic unit for the flameless combustion of the hydrogen having at least one catalyst for catalyzing the hydrogen. Additionally or alternatively, according to at least one aspect of the present subject matter, the provision unit includes an electrolyzer for generating hydrogen and/or a water supply for supplying the electrolyzer with water, wherein the water supply preferably includes a collection device for collecting water, in particular rain water, and/or preferably a treatment device for treating the water.

If the appliance includes the reaction unit, which is in the form of a catalytic unit, the thermal energy is generated by catalyzing the reaction gas mixture. Since the reaction gas mixture is catalyzed in the catalyst by means of the reaction unit, the thermal energy is flamelessly generated. The hydrogen content of the supplied reaction gas mixture is preferably outside of the explosive range, in particular, less than 4% by volume. As a result, an explosion of the reaction gas mixture can be prevented.

If the provision unit additionally or alternatively includes the electrolyzer, the electrolyzer splits the water supplied by the water supply into hydrogen and oxygen by means of water electrolysis. If the water supply preferably has the collection device, for example, rain water can be collected. To this end, it is advantageous when at least the collection device of the water supply is placed outdoors and, thus, can catch and/or collect the rain water when it rains. The collection device can, in particular indirectly, provide the water for the electrolysis. This has the advantage that the appliance can be operated regardless of where it is set up. Since water can be additionally collected from the surroundings, the operating costs of the appliance can be reduced. If the water supply additionally or alternatively has the treatment device, contaminated water such as rain water, ground water, surface water and/or tap water can be at least partially treated such that the water is suitable for the electrolysis in the electrolyzer. The treated water can be referred to as pure water. Larger and/or smaller contaminants can be removed during treatment. Similarly, it is conceivable that additives necessary for the water electrolysis are supplied to the water by means of the treatment device. As a result, at least some water which is contaminated and/or unsuitable prior to treatment can also be used for the water electrolysis.

When the appliance has the reaction unit, which is in the form of a catalytic unit, it is advantageous when the reaction unit includes a catalytic combustion chamber in which the catalyst is arranged.

It is also advantageous when the catalyst is arranged in the combustion chamber such that the catalyst forms a permeable partition, which subdivides the combustion chamber into two sub-chambers. Advantageously, the catalyst is in the form of a permeable lattice in this case.

In an advantageous development of the present subject matter, the catalyst is permeable, in particular in the form of a lattice, and/or hydrophilic. Preferably, the catalyst is made of titanium and/or provided with a metal oxide-platinum coating.

Moreover, it is advantageous when the combustion chamber has a mixture inlet for an air-hydrogen mixture, in particular in a first sub-chamber, and an outlet opening for a catalytically heated air flow, in particular in a second sub-chamber. This heated air flow is used for heating food and/or for emitting heat for heating buildings and/or persons.

Furthermore, it is advantageous when the mixture inlet is arranged on a first end of the combustion chamber in the longitudinal direction of the combustion chamber and the outlet opening is arranged on an opposite, second end of the combustion chamber.

In an advantageous development of the present subject matter, the reaction unit, which is in the form of a catalytic unit, has an, in particular electric, auxiliary heating system for heating and/or drying the catalyst. Advantageously, the auxiliary heating system is in the form of a jacket heating element and/or extends around the combustion chamber in the region of the catalyst. When the appliance is started, condensation can be present on the, in particular hydrophilic, catalyst, which can hinder a reliable start of the flameless catalytic combustion. By means of the auxiliary heating system, the catalyst can be heated and/or dried prior to and/or during the starting process, and therefore the reaction unit can be reliably started.

For the purpose of monitoring the starting process and/or the flameless catalytic combustion, it is advantageous when the reaction unit, which is in the form of a catalytic unit, includes a temperature sensor. Preferably, this temperature sensor is arranged in or in the region of the combustion chamber. The temperature sensor is used to indicate whether the combustion process is running and heat is being generated. Additionally or alternatively, the temperature sensor or its data, in particular from a controller, can be used for the closed-loop control of the amount of supplied hydrogen and/or of the supplied air.

It is advantageous when the reaction unit, which is in the form of a catalytic unit, includes a mixing chamber into which hydrogen and air can be supplied and mixed with one another to form the air-hydrogen mixture. In this regard, it is advantageous, furthermore, when the mixing chamber has an inlet opening for air, a hydrogen inlet for hydrogen and/or a mixture outlet.

A structurally simple implementation can be ensured when, advantageously, the inlet opening is arranged on a first end of the mixing chamber in the longitudinal direction of the mixing chamber, the mixture outlet is arranged on an opposite, second end of the mixing chamber and/or the hydrogen inlet is arranged between these two ends.

In order to be able to ensure that the hydrogen flowing into the mixing chamber is reliably mixed with the air, which is also inflowing, it is advantageous when the mixing chamber has a first section, which tapers, in particular conically, from the inlet opening towards the mixture outlet and a, in particular cylindrical and/or constant-diameter, second section and/or a, in particular conically, widening third section. In this regard, it is advantageous, furthermore, when the hydrogen inlet is arranged in the region of the second section.

It is advantageous when the reaction unit, which is in the form of a catalytic unit, includes a fan and/or a bypass air opening for supplying air into the mixing chamber, in particular via the inlet opening.

It is also advantageous when the reaction unit, which is in the form of a catalytic unit, includes a sensor for determining the mixing ratio of the air-hydrogen mixture. In this regard, it is also advantageous when the catalytic unit includes a sensor chamber, which is preferably arranged between the mixing chamber and the combustion chamber. Preferably, the sensor for determining the mixing ratio of the air-hydrogen mixture is arranged in this sensor chamber.

The structural complexity of the appliance can be reduced when the mixing chamber, the sensor chamber and/or the combustion chamber are/is in the form of a pipe, at the one end of which the inlet opening is arranged and at the other end of which the outlet opening is arranged. For simple maintenance and repair, it is advantageous, furthermore, when the pipe includes multiple pipe elements, which are, in particular detachably, connected to one another and which preferably have at least one of the chambers. Thus, the pipe can have, for example, a first pipe element including the mixing chamber, a second pipe element including the sensor chamber and/or a third pipe element including the combustion chamber. These can be detachably connected to one another in correspondingly designed connection areas. Preferably, the connection areas are in the form of flanges, which are bolted together with bolts.

In order to be able to ensure a reliable start and/or reliable catalytic, flameless combustion, it is advantageous when the reaction unit, which is in the form of a catalytic unit, includes a controller for the open-loop control and/or closed-loop control of the mixing ratio of the air-hydrogen mixture and/or of the auxiliary heating system. To this end, it is advantageous when the controller is connected to the sensor for determining the mixing ratio of the air-hydrogen mixture, to the temperature sensor, which is arranged, in particular, in the combustion chamber, to the fan and/or to a hydrogen valve for controlling the supply of hydrogen. The heat output of the appliance can be controlled via an open-loop system by the controller preferably via the air volume and/or amount of hydrogen supplied to the mixing chamber. Preferably, the air volume is regulated by way of the controller appropriately actuating the fan. Additionally or alternatively, the amount of hydrogen is regulated by way of the hydrogen valve being appropriately actuated by the controller. For this temperature regulation, the controller receives a target value, in particular a target temperature, from a user. These can be transmitted and/or predefined by the user preferably via an input/output interface of the appliance of the controller. The controller preferably receives an actual temperature via the temperature sensor and regulates this by appropriately actuating the fan and/or the hydrogen valve to the target temperature which has been predefined by the user. Additionally or alternatively, the controller can determine a target mixing ratio of the air-hydrogen mixture, in particular on the basis of the predefined target temperature. Additionally or alternatively, this target mixing ratio can be specified to the controller. Additionally or alternatively, target mixing ratios which have been mathematically and/or empirically determined and which correlate with the target temperature can be stored in a memory of the controller. The controller is preferably designed such that it adjusts the actual mixing ratio of the air-hydrogen mixture, which has been sensed via the sensor, to the target value on the basis of the target mixing ratio.

In order to be able to regulate the supplied amount of hydrogen, it is advantageous when the reaction unit, which is in the form of a catalytic unit, includes a hydrogen valve, which is actuatable by the controller and via which an inflow of hydrogen into the mixing chamber is controllable by way of an open-loop system.

It is advantageous when the provision unit includes a compressor for compressing the generated hydrogen. The hydrogen generated by the electrolyzer frequently has a low pressure. In order to be able to subsequently efficiently store and/or utilize the hydrogen, the hydrogen coming from the electrolyzer is supplied to the compressor and is compressed.

It is additionally advantageous when the provision unit has at least one accumulator for storing the hydrogen. The accumulator is preferably in the form of a pressure accumulator and/or a metal hydride accumulator. The hydrogen which has been generated by the electrolyzer and/or compressed by the compressor can be stored by means of the accumulator. An elevated gas pressure can be required and/or desirable, in particular, for filling the pressure accumulator, which elevated gas pressure can be provided by means of the compressor.

If the metal hydride accumulator and/or a very large pressure accumulator are/is used as the accumulator, a sufficient amount of hydrogen for the reaction unit can already be provided by means of the non-compressed hydrogen. The metal hydride accumulator is an accumulator which bonds the hydrogen to a metal mixture by means of a chemical storage process. This bond must be triggered by supplying heat in order to bind the hydrogen. The heat energy which is necessary for releasing the hydrogen from the metal hydride accumulator and subsequently using this by means of the reaction unit can be provided via heated exhaust air from the appliance and/or via a separate heat source.

It is advantageous when the at least one accumulator is in the form of a main accumulator and/or an intermediate accumulator. The intermediate accumulator is preferably designed to store the hydrogen generated by the electrolyzer prior to compression and the main accumulator is designed to store the hydrogen which has been compressed by the compressor. The hydrogen generated by the electrolyzer is preferably stored in the intermediate accumulator under the output pressure of the electrolyzer. The hydrogen has a maximum pressure of 35 bar in the intermediate accumulator and/or at the outlet of the electrolyzer. Thereafter, the hydrogen is directed from the intermediate accumulator into the compressor, in which the hydrogen is compressed from the output pressure to the storage pressure. The compressed hydrogen is subsequently stored in the main accumulator. The hydrogen has a pressure greater than 35 bar, preferably maximally 200 bar, in the main accumulator and/or at the outlet of the compressor.

Similarly, it is advantageous when the treatment device has at least one filter for filtering the water. By means of the filter, the water, in particular the rain water, ground water, surface water and/or tap water, can be filtered and/or purified. The at least one filter is preferably in the form of a reverse osmosis filter, a prefilter and/or a filter screen.

The filter screen filters the most coarse contaminants from the water. If the appliance includes a collection device, the filter screen is designed such that it filters out the most coarse contaminants, in particular leaves and/or twigs, in the region of the collection device. Due to the arrangement on the collection device, the filter screen can be cleaned without considerable modifications. The prefilter filters moderate contaminants out of the water. The prefilter is preferably in the form of an easily accessible through filter. This is also easy to clean. A reverse osmosis filter should be understood to mean a filter which treats the water which is flowing through by means of reverse osmosis. The water which has been treated by means of reverse osmosis can be referred to as pure water, wherein the pure water preferably has a maximum conductivity of 20 microsiemens.

Preferably, at least one of the filters, in particular the prefilter and/or the filter screen, is arranged on the appliance such that necessary cleaning work can be carried out quickly and easily. Moreover, it is advantageous when the treatment device has a blockage sensor, in particular in the region of the prefilter. As a result, the operation of the treatment device can always be ensured.

It is advantageous, in addition, when the water supply includes at least one water tank for storing water, wherein the at least one water tank is preferably in the form of an intermediate tank for storing the collected water and/or in the form of a pure water tank for storing the filtered water, in particular the pure water. In addition, it is advantageous when the at least one water tank, in particular the pure water tank, has a quality sensor for monitoring the water quality.

Similarly, it is advantageous when the water supply has at least one outflow element for withdrawing water from the at least one water tank, the treatment device and/or the collection device. As a result, water which is unneeded, for example, if the at least one water tank is already completely filled and/or if the treatment device and/or the collection device are/is clogged, can be discharged. Similarly, the at least one outflow element can act as emergency drainage for necessary maintenance work.

Additionally or alternatively, it is advantageous when the water supply has at least one anti-frost device for preventing damage due to frost. The at least one anti-frost device can be in the form of thermal insulation and/or heating. Additionally or alternatively, the at least one anti-frost device can be in the form of an outflow element for draining the water supply.

It is advantageous when the reaction unit, which is in the form of a catalytic unit, includes a fan and/or a bypass air opening for supplying air, a mixing chamber for mixing the hydrogen with the air, a sensor for determining the mixing ratio, a controller for controlling the mixing ratio and/or the catalyst for catalyzing the hydrogen. The fan and/or the bypass air opening preferably supplies ambient air to the catalytic unit. The reaction gas mixture arises when the hydrogen is mixed with the air. The reaction gas mixture is preferably controlled by an open-loop system such that the hydrogen content is outside of the explosive range, in particular less than 4% by volume. The thermal energy for heating food and/or for emitting heat, in particular thermal radiation and/or a warm air flow, to the surroundings is generated from the reaction gas mixture by means of the catalyst.

It is also advantageous when the reaction unit is in the form of a burner unit for burning the hydrogen. In addition, it is advantageous when the burner unit has at least one igniter, a fire indicator and/or a combustion pipe. A burner unit should be understood here to mean a reaction unit, which generates thermal energy from the hydrogen by means of an open flame. The reaction gas mixture made up of hydrogen, air and oxygen exits at the at least one combustion pipe and is ignited by means of the at least one igniter, as a result of which a flame is formed. Since the flame from the reaction gas mixture with hydrogen burns colorlessly, the presence of the flame can be detected and/or displayed by means of a fire indicator. In this way, safety can be ensured when thermal energy is generated from the hydrogen by means of open flame.

It is additionally advantageous when the appliance includes a power supply, wherein the power supply preferably has at least one current source, in particular a photovoltaic cell, a wind turbine and/or an external current feed. By means of the power supply, all components of the appliance, in particular the electrolyzer, the treatment device, the reaction unit, the compressor, the water tank and/or a computer unit, can be supplied with current and their operation can be ensured. The photovoltaic cell and/or the wind turbine depend on environmental influences. The photovoltaic cell converts solar energy into current and the wind turbine converts wind energy into current. In so doing, it can be advantageous when the electrolyzer generates hydrogen at the points in time at which the photovoltaic cell and/or the wind turbine deliver(s) current. If the current source, additionally or alternatively, is in the form of an external current feed, this can be used regardless of environmental influences and/or act as support for the photovoltaic cell and/or the wind turbine. Preferably, the external current feed has a voltage converter. The voltage converter can convert the input voltage, as a result of which the external current feed is suitable for different network voltages.

Additionally or alternatively, it is advantageous when the appliance has an energy accumulator, in particular a storage battery. If the current source is in the form of a photovoltaic cell and/or a wind turbine, the introduced energy can be stored by means of the energy accumulator and output at any time. As a result, the appliance can also be operated in unfavorable environmental conditions. Similarly, it is conceivable that the energy accumulator is charged via a mains connection in the case of an appliance having exclusive external current feed. This energy which is stored in the energy accumulator can be subsequently output to the components of the appliance during mobile operation.

Additionally or alternatively, it is advantageous when the appliance has a current distributor for distributing the current. By means of the current distributor, the current from the current source can be distributed to all components of the appliance, in particular to the electrolyzer, to the treatment device, to the reaction unit, to the compressor, to the water tank and/or to the computer unit.

Additionally or alternatively, it is advantageous when the appliance includes a current converter for converting the type of current, in particular from direct current to alternating current.

It is advantageous when the appliance has at least one computer unit for the open-loop and/or closed-loop control of the appliance, in particular of the provision unit, the reaction unit and/or the power supply. Additionally or alternatively, the appliance has at least one operating unit for operating the appliance, in particular the provision unit, the reaction unit and/or the power supply.

Similarly, it is advantageous when the appliance has a cooling air device, preferably having at least one air inlet and/or a cooling fan. As a result, the appliance, in particular the provision unit, the reaction unit, the power supply and/or the computer unit, can be supplied with cool air. It is also conceivable that the anti-frost device and the cooling air device are provided by a common device, which can heat as well as cool.

Similarly, it is advantageous when the appliance is in the form of an autonomously operable grill and/or radiant heater, wherein the provision unit, the reaction unit, the power supply and/or the computer unit are/is preferably arranged in a housing and/or are mechanically connected to one another. An autonomously operable appliance should be understood to mean an appliance which can be operated essentially without foreign substances supplied from the outside, in particular manually. For example, rain water is automatically collected by means of the collection device and, after having been treated and/or filtered, is stored in the at least one water tank. Energy accumulators can be charged and/or the appliance can be operated by means of the current source in the form of photovoltaic cells and/or a wind turbine. Hydrogen is generated from the filtered rain water, in particular from the pure water, by means of the electrolyzer and stored in at least one of the accumulators. Heat can then be generated by means of the at least one reaction unit. If the provision unit, the reaction unit, the power supply and/or the computer unit, additionally or alternatively, are/is arranged in a housing and/or mechanically connected to one another, the appliance can be designed to be transportable as a unit.

It is also advantageous when the housing has a main body and/or a roof, wherein the main body and the roof are preferably connected to one another by means of at least one connecting device and/or the housing is in the form of a two-part, mechanically interconnected unit by means of the connecting device. The roof can act as rain protection and/or sun protection, as a result of which the main body, in particular the reaction unit which is arranged on the main body, is protected against environmental influences.

It is also advantageous when the current source, in particular in the form of a photovoltaic cell, and/or the collection device are/is arranged on the roof and/or on a rear face of the housing and/or the roof and/or forms the rear face of the housing.

It is additionally advantageous when the at least one connecting device is in the form of a mechanical connecting device and/or at least one connecting cable and/or at least one rain water line are/is arranged in the region of the connecting device. The mechanical connecting device can mechanically connect the main body to the roof. As a result, the mechanical connecting device can be formed, at least partially, as a support frame of the housing. The support frame can, additionally or alternatively, accommodate the components of the appliance, in particular the at least one provision unit, the at least one reaction unit, the power supply and/or the computer unit.

The connecting cable can electrically connect the current source arranged on the roof to the provision unit arranged in the main body, to the reaction unit, the computer unit, the energy accumulator, the current distributor and/or the current converter. The connecting cable can be in the form of at least one electrical conductor, in particular a cable. The rain water line can direct the rain water collected by the collection device arranged on the roof to the at least one water tank and/or to at least one of the filters in the main body. The rain water line can be in the form of a down pipe. Preferably, as described above, at least one of the filter elements, in particular the filter screen, is arranged in the region of the roof. In this way, coarse contaminants do not enter the down pipe and remain on the roof.

Moreover, it is advantageous when the roof is movable, in particular displaceable and/or swivelable. As a result, the photovoltaic cell and/or the collection device can be oriented toward the solar radiation and/or toward the rain. In addition, a movable roof can be used to keep environmental influences away from the main body, in particular from the reaction unit on the main body. In this way, the roof can be displaced toward the main body, in particular during harsh weather, in order to protect the main body.

It is also advantageous when the appliance has a grill unit as a grill and/or a heating unit as a radiant heater, wherein the reaction unit is preferably at least partially arranged within the grill unit and/or the heating unit, and/or the grill unit and/or the heating unit are/is operatively connected to the reaction unit.

A grill unit should be understood to mean a unit within which and/or on which the food can be heated. Preferably, the grill unit is in the form of a closed grill unit in which a roof can be opened and/or a base is stationary. The reaction unit is arranged in the region of the base and/or introduces the thermal energy into the grill unit in the region of the base. Food can be placed into the grill unit and removed therefrom by means of the roof. A heating unit should be understood to mean a unit which can emit heat to the surroundings, in particular by means of thermal radiation and/or a warm air flow. The reaction unit is arranged in the heating unit and, in particular, is visible from the outside.

Moreover, it is advantageous when the grill unit has at least one grate and/or a deflector element, wherein the deflector element is preferably arranged between the grate and the reaction unit such that food lying on the grate can be, in particular exclusively, indirectly heated. The deflector element can preferably be in the form of a plate and/or a hollow body which is closed on one side. If the deflector element is in the form of a hollow body which is closed on one side, the main opening is oriented toward the reaction unit in a vertical direction. The hollow body is closed in the vertical direction. Advantageously, the hollow body which is closed on one side has additional lateral secondary openings, as a result of which the hollow body that is closed on one side is at least partially open in the transverse direction. Air which has been heated by the reaction unit can flow, in particular indirectly, through these secondary openings to the grate and, thus, to the food lying thereon. As a result, the food can be indirectly heated.

It is additionally advantageous when the appliance has at least one lighting device, at least one camera and/or at least one temperature sensor, in particular in the region of the grill unit. The appliance can be illuminated by means of the lighting device, in particular in the region of the grill unit and/or toward the base. The appliance can be monitored, in particular in the region of the grill unit, by means of the at least one camera and/or the temperature sensor. As a result, the food, in particular its doneness, can be monitored.

It is advantageous when the appliance has a danger detection device and/or a danger alarm device.

In another aspect, the present subject matter relates to a method for operating an appliance for heating food and/or for emitting heat, in particular thermal radiation and/or a warm air flow, to the surroundings, wherein hydrogen is provided by means of at least one provision unit, and wherein heat is generated from the provided hydrogen by means of at least one reaction unit. According to at least one aspect of the present subject matter, hydrogen is generated by means of electrolysis from water provided by a water supply, wherein water, in particular rain water, is collected by means of a collection device and/or is treated by means of a treatment device. Additionally or alternatively, the hydrogen is catalyzed according to at least one aspect of the present subject matter by means of at least one catalyst via a reaction unit, which is in the form of a catalytic unit.

The appliance is preferably designed according to the preceding description, wherein the aforementioned features can be present individually or in any combination.

It is advantageous when the appliance is switched, in particular by means of the operating unit, to an operating setting in which the hydrogen for heating food and/or for emitting heat, in particular thermal radiation and/or a warm air flow, to the surroundings is consumed by the reaction unit and/or the hydrogen is provided by the provision unit of the reaction unit and, after the termination of the operating setting, the appliance is switched, in particular by means of the reaction unit, to a production setting in which the hydrogen is produced by means of the at least one provision unit. Appliances according to at least one aspect of the present subject matter, in particular grills and/or radiant heaters, are seldom operated in their operating setting. The appliance therefore usually assumes the production setting and only rarely assumes the operating setting. As a result, hydrogen can be produced by means of the provision unit for a long period of time.

As a result, it can be ensured that a sufficient amount of hydrogen is always available for operating the appliance.

### BRIEF DESCRIPTION OF THE FIGURES

Further advantages of the invention are described in the following exemplary embodiments, wherein:

FIG. 1 shows a highly simplified schematic sectional view of an appliance according to one exemplary embodiment, and

FIG. 2 shows a highly simplified schematic sectional view of an appliance according to an alternative exemplary embodiment.

### DETAILED DESCRIPTION

In the following description of the figures, the same reference characters are used for features that are identical and/or at least comparable in each of the various figures. The individual features, their embodiment and/or mode of operation are explained in detail usually only upon the first mention thereof. If individual features are not explained in detail once more, their embodiment and/or mode of operation correspond(s) to the embodiment and mode of operation of the features described above.

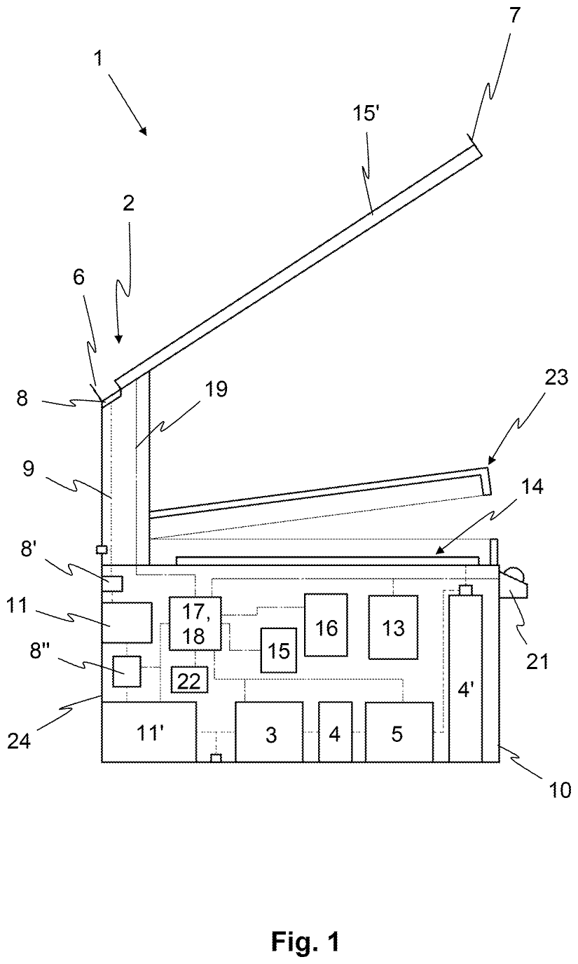

FIG. 1 shows a highly simplified schematic sectional view of an appliance 1 according to one exemplary embodiment. The appliance 1 shown here is an appliance for heating food, in particular a grill for outside. Additionally or alternatively, the appliance can be designed to emit heat, in particular thermal radiation and/or a warm air flow, to the surroundings.

The appliance 1 has a provision unit 2 for providing hydrogen. When the provision unit 2 is in the form of a hydrogen production unit as in the present exemplary embodiment, the provision unit 2 can include a plurality of components, which are distributed in many regions of the appliance 1. For example, the provision unit 2 here includes a water supply, an electrolyzer 3, at least one accumulator 4, 4′ and a compressor 5.

The water supply supplies the electrolyzer 3 with water. In the exemplary embodiment shown, rain water is collected by means of a collection device 6, which is arranged on a roof 7 of the appliance 1. The rain water is collected across the entire roof 7 and is guided downward due to the pitch of the roof. The collected rain water is subsequently treated by means of a treatment device 8, 8′, 8″. A filter screen 8, which is arranged in the region of the collection device 6 on the roof 7 of the appliance 1, in particular at the lowest point on the roof 7, filters coarse contaminants out of the rain water. By means of a rain water line 9, which is arranged in the region of and/or within a connecting device of the appliance 1, the rain water is directed from the roof 7 of the appliance 1 into a main body 10 of the appliance 1. The connecting device mechanically connects the roof 7 and the main body 10 of the appliance 1 to one another, as a result of which a housing is formed.

In the main body 10, the rain water is guided into a prefilter 8′ by means of the rain water line 9. There, the rain water is further treated and further contaminants are filtered out. The rain water, which has now been treated, is delivered to an intermediate tank 11. Thereafter, the treated rain water is conducted from the intermediate tank 11 to a reverse osmosis filter 8″ in which the treated rain water is further treated. The water, which has been treated by means of the treatment device 8, 8′, 8″, which includes the filter screen 8, the prefilter 8′ and/or the reverse osmosis filter 8″, can be referred to as filtered water and/or pure water. The filtered water and/or the pure water is subsequently directed to a pure water tank 11′ and stored therein. It is also conceivable that the water is conducted directly from the prefilter 8′ instead of the intermediate tank 11 into the reverse osmosis filter 8″.

If the intermediate tank 11 and/or the pure water tank 11′ are/is completed filled, the excess water can be transported out of the appliance 1 by means of at least one outflow element. The control for opening these outflow elements can be carried out by means of a computer unit 13. As is shown here, all components of the water supply, in particular the collection device 6, the filter screen 8, the prefilter 8′, the intermediate tank 11, the reverse osmosis filter 8″, the pure water tank 11′ and/or the two outflow elements, can be connected to one another by means of at least one water line.

The water from the water supply, in particular from the pure water tank 11′, is delivered to the electrolyzer 3 for generating hydrogen. The electrolyzer 3 produces the hydrogen from the water by means of electrolysis. The hydrogen which has been generated as a result is transported to an intermediate accumulator 4. In order to store the hydrogen in a main accumulator 4′ under a higher pressure, the hydrogen is initially compressed by means of the compressor 5. Due to the compression, a considerably greater amount of hydrogen can be stored in the main accumulator 4′. The connection of the individual components is in the form of a water line or a gas line depending on the medium to be conducted, in particular water or hydrogen. These lines are indicated in FIG. 1 as dashed lines between the individual components.

In the exemplary embodiment shown, the main accumulator 4′ is in the form of a pressure accumulator for compressed hydrogen. It is also conceivable that the main accumulator 4′ is in the form of a metal hydride accumulator. The compressor 5 and the intermediate accumulator 4 are not absolutely necessary for such a metal hydride accumulator, as a result of which these can be eliminated in this type of design of the appliance 1.

Thereafter, the hydrogen for operating at least one reaction unit 14 can be withdrawn from the main accumulator 4′. Since, as described above, the main accumulator 4′, as a pressure accumulator, stores the hydrogen under an elevated pressure, a pressure reducer may be necessary for operating the reaction unit 14. Moreover, a pressure distribution may be necessary for operating a plurality of reaction units 14.

In the exemplary embodiment shown, the appliance 1 also has a power supply. The power supply has at least one current source 15, 15′, at least one energy accumulator 16, at least one current distributor 17 and/or at least one current converter 18. In the exemplary embodiment shown, two current sources 15, 15′ are in the form of an external current feed 15 and a photovoltaic cell 15′. The external current feed 15 is arranged in the region of the main body 10 of the appliance 1. Externally generated current can be introduced into the appliance 1 by means of the external current feed 15. The external current feed 15 can include a voltage converter, which converts the voltage of the current such that the current can be used within the appliance 1. It is also conceivable that only one of the current sources 15, 15′ and/or, instead, a wind turbine, are/is used as a current source.

The photovoltaic cell 15′ is arranged in the region of the roof 7 of the appliance 1. As a result, the photovoltaic cell 15′ can convert the solar radiation incident thereon into electricity or current. The current from the photovoltaic cell 15′ is conducted from the roof 7 to the main body 10, in particular to the current distributor 17 arranged therein, by means of a connecting cable 19, which is arranged in the region of and/or within the connecting device. From the current distributor 17, the current which has been supplied by the current source(s) 15, 15′ and/or stored in the energy accumulator 16 is distributed to all components of the appliance 1. In addition, the current converter 18 arranged on the current distributor 17 can convert the type of current. Excess current or energy, or current or energy that is not needed at the moment can be stored in the energy storage device 16. This energy can then be output from the energy storage unit 16 to components of the appliance 1 when these components require the current or the energy. This can also be the case when both current sources 15, 15′ are not delivering any current at the moment.

In the exemplary embodiment shown, the current is distributed by means of the current distributor 17 to the reverse osmosis filter 8″, to the pure water tank 11′, to the electrolyzer 3, to the compressor 5, to the computer unit 13, to the energy accumulator 16, to an operating unit 21 and/or to an anti-frost device 22. This connection, in particular an electrical connection to the power supply and/or data connections, between the aforementioned components, is shown as a dash-dotted line in FIG. 1 in each case.

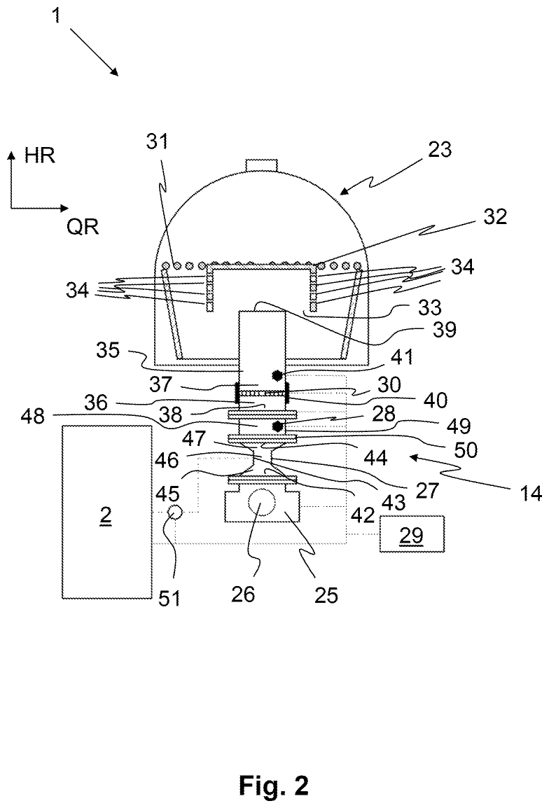

In the exemplary embodiment shown, the operating unit 21 of the appliance 1 is used for operating the provision unit 2, the reaction unit 14 and/or the power supply. By activating the reaction unit 14, the hydrogen which has been generated and provided by the provision unit 2 can be consumed or utilized, for example, to heat food within a grill unit 23. The reaction unit 14 is arranged within the grill unit 23. Alternatively, the reaction unit 14 can be arranged outside the grill unit 23 and be operatively connected thereto, for example, by means of a heat-conducting element. In addition, the grill unit 23 can be designed similarly to the exemplary embodiment from FIG. 2.

The appliance 1 is switched into the operating setting during the consumption and/or utilization of the hydrogen by the reaction unit 14. The operating unit 21 outputs a signal to the computer unit 13, which can appropriately control the individual components. It is conceivable that, in the operating setting, only the hydrogen which has been previously generated by the provision unit 2 is used for operating the reaction unit 14. It is also conceivable that, in addition, during the operation of the reaction unit 14, hydrogen is provided by means of the provision unit 2 and/or utilized directly or indirectly by the reaction unit 14.

If the operating setting is terminated by means of the operating unit 21, the computer unit 13 switches the appliance 1, in particular automatically, into a production setting. The reaction unit 14 is switched off in the production setting. Hydrogen is therefore not consumed. In the production setting, hydrogen is generated or produced by means of the provision unit 2. If the appliance 1 should be subsequently switched back to the operating setting, the hydrogen which has been newly generated or produced by the provision unit 2 can be utilized by means of the reaction unit 14. Since the appliance 1 is usually in the production setting, the generation and/or production of hydrogen can be controlled via a closed-loop system depending on environmental influences such that the operating costs are minimal. For example, rain water can be collected in the water tanks 11, 11′ in advance and, when the sun comes out later, the electrolyzer 3 can be operated by means of solar energy from the photovoltaic cell 15′. In this way, the energy consumption which can be supplied by means of the external current feed 15 is minimized.

The appliance 1 also has the anti-frost device 22. The anti-frost device 22 can heat and/or insulate components of the appliance 1, in particular the at least one water tank 11, 11′. It is also conceivable that, additionally or alternatively, the anti-frost device 22 is in the form of a cooling air device and, thus, cools the components of the appliance 1.

Additionally or alternatively, it is conceivable that the collection device 6 and/or the photovoltaic cell 15′ are/is arranged on a rear face 24 of the appliance 1. To this end, the rear face 24 can have, for example, a receiving element for receiving the collection device 6 and/or the photovoltaic cell 15′ and/or the rear face 24 can be inclined similarly to the roof 7 which is shown here.

FIG. 2 shows a highly simplified schematic sectional view of an appliance 1 according to an alternative exemplary embodiment. The exemplary embodiment from FIG. 2 also shows an appliance for heating food, in particular a grill for outside. Additionally or alternatively, the appliance can be designed to emit heat, in particular thermal radiation and/or a warm air flow, to the surroundings.

The provision unit 2 for providing the hydrogen is shown in a highly simplified manner in the exemplary embodiment shown. The provision unit 2 can be in the form of a simple hydrogen store and/or a provision unit 2 according to the exemplary embodiment from FIG. 1. The reaction unit 14 is in the form of a catalytic unit. The reaction unit 14, which is in the form of a catalytic unit, which is explained in detail in the following, can also be used in the exemplary embodiment from FIG. 1.

The reaction unit 14, which is in the form of a catalytic unit, has a fan 25 and a bypass air opening 26 for supplying air and/or oxygen, a mixing chamber 27 for mixing the hydrogen with the air and/or with the oxygen, a sensor 28 for determining the mixing ratio of the reaction mixture, a controller 29 for controlling the mixing ratio and/or a catalyst 30 for catalyzing the reaction mixture.

The supplied air and/or the oxygen from the fan 25 and/or from the bypass air opening 26 are/is mixed with the hydrogen provided by the provision unit 2 in the mixing chamber 27. The mixing ratio of the reaction gas mixture made of up hydrogen and air and/or oxygen can be controlled via an open-loop and/or closed-loop system by means of the sensor 28, a hydrogen valve 51, the fan 25, the bypass air opening and/or the controller 29. Thus, it can be ensured that the reaction gas mixture supplied to the catalyst 30 has an appropriate ratio. The reaction gas mixture should have at most 4% by volume of hydrogen in order to avoid explosions. To this end, the provision unit 2 can have a mass flowmeter, which is connected to the controller 29 such that the hydrogen is optimally supplied to the mixing chamber 27.

The reaction unit 14 projects in a vertical direction HR with the catalyst 30 into the grill unit 23. The grill unit 23 has a grate 31 and/or a deflector element 32 for heating the food. The deflector element 32, as is shown here, is arranged between the grate 31 and the reaction unit 14 such that food lying on the grate 31 can be indirectly heated.

To this end, the deflector element 32 is in the form of a hollow body which is closed on one side, wherein a main opening 33 in the deflector element 32 is open in the vertical direction HR towards the reaction unit 14. The hollow body is therefore closed in the vertical direction HR. In order to uniformly indirectly heat the food, the deflector element 32 has laterally open auxiliary elements 34, as a result of which the heat of the reaction unit 14 can propagate in the entire grill unit 23.

The reaction unit 14, which is in the form of a catalytic unit, includes a catalytic combustion chamber 35 in which the catalyst 30 is arranged. The catalyst 30 is arranged in the combustion chamber 35 such that the catalyst 30 forms a permeable partition, which subdivides the combustion chamber 35 into two sub-chambers 36, 37. In the present exemplary embodiment, the catalyst 30 is in the form of a permeable lattice. Furthermore, the catalyst 30 can be hydrophilic. Preferably, the catalyst 30 is made of titanium and/or is in the form of a metal oxide-platinum coating.

The combustion chamber has a mixture inlet 38 for the air-hydrogen mixture in the first sub-chamber 36 and an outlet opening 39 for the catalytically heated air flow in the second sub-chamber 37. This heated air flow is used for heating food, according to the exemplary embodiment shown in FIG. 2. Similarly, according to an exemplary embodiment which is not shown, the heated air flow can be used to emit heat to the surroundings, in particular for heating buildings and/or persons.

According to FIG. 2, the mixture inlet 38 is arranged on a first end of the combustion chamber 35 in the longitudinal direction of the combustion chamber 35 and the outlet opening 39 is arranged on an opposite, second end of the combustion chamber 35. The reaction unit 14, which is in the form of a catalytic unit, includes an, in particular electric, auxiliary heating system 40 for heating and/or drying the catalyst 30. Thus, condensation can be present on the, in particular hydrophilic, catalyst 30, when the appliance is started, which condensation can hinder a reliable start of the flameless catalytic combustion. The catalyst 30 can be heated and/or dried prior to and/or during the starting process by means of the auxiliary heating system 40, and therefore the reaction unit 14, which is in the form of a catalytic unit, can be reliably started. The auxiliary heating system 40 can be in the form of a jacket heating element. In this case, the auxiliary heating system 40 or an annular heating element of the auxiliary heating system 40 can be located outside of the combustion chamber 35. The jacket heating element is then arranged on the outer circumference of the combustion chamber 35 in the region of the catalyst 30. As a result, the catalyst 30 is indirectly heated via the auxiliary heating system 40 via the housing of the combustion chamber 35.

For monitoring the starting process and/or the flameless catalytic combustion, the reaction unit 14, which is in the form of a catalytic unit, includes a temperature sensor 41, which is arranged in the combustion chamber 35 or in the region of the combustion chamber 35. Preferably, the temperature sensor 41 is arranged in the second sub-chamber 37, as is shown in FIG. 2. By utilizing the data which are transmitted from the temperature sensor 41 to the controller 29, an ignition of the air-hydrogen mixture and/or an explosion can be avoided by the controller 29, in particular by means of closed-loop control of the auxiliary heating system 40 and/or the hydrogen valve 51.

As mentioned above, hydrogen is fed into the mixing chamber 27 and mixed with air, in particular via the hydrogen valve 51 and/or so as to be controlled by a closed-loop and/or open-loop system by the controller 29. To this end, the mixing chamber 27 has an inlet opening 42 for air, a hydrogen inlet 43 for hydrogen and/or a mixture outlet 44. The air-hydrogen mixture is fed to a sensor chamber 48 via the mixture outlet 44. A structurally simple implementation can be ensured when the inlet opening 42 is arranged on a first end of the mixing chamber 27 in the longitudinal direction of the mixing chamber 27, the mixture outlet 44 is arranged on an opposite, second end of the mixing chamber 27 and/or the hydrogen inlet 43 is arranged between these two ends.

In order to ensure that the hydrogen flowing into the mixing chamber 27 is reliably mixed with the air, which is also inflowing, the mixing chamber 27 has a first section 45, which tapers, in particular conically, from the inlet opening 42 towards the mixture outlet 44 and a, in particular cylindrical and/or constant-diameter, second section 46 and/or a, in particular conically, widening third section 47. The hydrogen inlet 43 is arranged in the region of the second section 46. Air is supplied from the fan and/or the bypass air opening to the mixing chamber 27 via the inlet opening 42.

The sensor chamber 48 is arranged between the mixing chamber 27 and the combustion chamber 35. The sensor 28 for determining the mixing ratio of the air-hydrogen mixture is arranged in the sensor chamber 35.

The structural complexity of the appliance 1 can be reduced when the mixing chamber 27, the sensor chamber 48 and/or the combustion chamber 35 are/is in the form of a pipe, at the one end of which the inlet opening 42 is arranged and at the other end of which the outlet opening 39 is arranged. For simple maintenance and repair, it is advantageous, furthermore, when the pipe includes multiple pipe elements 49 according to FIG. 2, which are, in particular detachably, connected to one another. For the sake of clarity, only one of these pipe elements 49 is labeled with a reference character in FIG. 2. Thus, the pipe according to the present exemplary embodiment includes a first pipe element having the mixing chamber 27, a second pipe element having the sensor chamber 48 and/or a third pipe element having the combustion chamber 35. These can be detachably connected to one another in correspondingly designed connection regions 50, wherein only one of the connection regions 50 is provided with a reference character here as well for the sake of clarity. Preferably, the connection areas 50 are in the form of flanges, which are bolted together.

In order to be able to ensure a reliable start and/or reliable catalytic, flameless combustion, the controller 29 is designed for the open-loop and/or closed-loop control of the hydrogen valve 51, the fan 25 and/or the auxiliary heating system 40. To this end, it is advantageous when the controller 29 is electrically connected to the sensor 28 for determining the mixing ratio of the air-hydrogen mixture and/or to the temperature sensor 41.

The heat output of the appliance 1 can preferably be controlled via an open-loop system by the controller 29 via the air volume and/or amount of hydrogen supplied to the mixing chamber 27. Preferably, the air volume is regulated by way of the fan 25 being appropriately actuated by the controller 29. Additionally or alternatively, the amount of hydrogen is regulated by means of the hydrogen valve 51 being appropriately actuated by the controller 29. For this temperature regulation, the controller 29 receives a target value, in particular a target temperature, from the user. This can be transmitted and/or predefined to the controller 29 by the user preferably via an input/output device (not shown here) of the appliance 1. The controller 29 receives an actual temperature preferably via the temperature sensor 41 and controls this via a closed-loop system to the target temperature predefined by the user by appropriately actuating the fan 25 and/or the hydrogen valve 51. Additionally or alternatively, the controller 29 can determine a target mixing ratio of the air-hydrogen mixture, in particular on the basis of the predefined target temperature. Additionally or alternatively, this target mixing ratio can be predefined to the controller 29. Additionally or alternatively, target mixing ratios which have been mathematically and/or empirically determined and which correlate with the target temperature can be stored in a memory (not shown here) of the controller 29. The controller 29 is preferably designed such that the controller 29 adjusts the actual mixing ratio of the air-hydrogen mixture, which has been sensed via the sensor 28, to the target value on the basis of the target mixing ratio.

The reaction unit 14, which is in the form of a catalytic unit, was described above as an example of the exemplary embodiment shown in FIG. 2. In principle, the reaction unit 14 can be used in any appliance 1 for heating food and/or for emitting heat, in particular thermal radiation and/or a warm air flow, to the surroundings preferably outside and/or inside. Thus, the reaction unit 14 can be integrated, for example, in a cooking appliance, a hot plate, a grill and/or an oven, in particular for outside and/or inside. Similarly, the reaction device 14 can be integrated in a heating appliance, a radiant heater, a fan heater, a chimney stove, a stationary heater, a patio heater and/or an open fireplace, in particular outside and/or inside. Outside and/or inside should be understood to mean the location of the appliance, at which the appliance can be operated. Thus, the location of the appliance outdoors and/or under open skies should be understood as outside. Inside should be understood as the location of the appliance in a building, house, tent, boat, motorhome and/or mobile home.

The present subject matter is not limited to the exemplary embodiments which have been shown and described. Modifications within the scope of the claims are also possible, as is any combination of the features, even if they are represented and described in different exemplary embodiments.

### LIST OF REFERENCE CHARACTERS

1 appliance
2 provision unit
3 electrolyzer
4, 4′ accumulator
5 compressor
6 collection device
7 roof
8, 8′, 8″ treatment device
9 rain water line
10 main body
11, 11′ water tank
13 computer unit
14 reaction unit
15, 15′ current source
16 energy accumulator
17 current distributor
18 current converter
19 connecting cable
21 operating unit
22 anti-frost device
23 grill unit
24 rear face
25 fan
26 bypass air opening
27 mixing chamber
28 sensor
29 controller
30 catalyst
31 grate
32 deflector element
33 main opening
34 secondary opening
35 combustion chamber
36 first sub-chamber
37 second sub-chamber
38 mixture inlet
39 outlet opening
40 auxiliary heating system
41 temperature sensor
42 inlet opening
43 hydrogen inlet
44 mixture outlet
45 first section
46 second section
47 third section
48 sensor chamber
49 pipe elements
50 connection region
51 hydrogen valve
HR vertical direction
QR transverse direction

1-31. (canceled)

32. An appliance for heating food and/or for emitting heat to the surroundings, the appliance comprising:
at least one provision unit for providing hydrogen; and
at least one reaction unit for generating heat from the hydrogen,
wherein:
the reaction unit comprises a catalytic unit for flameless combustion of the hydrogen, the catalytic unit including at least one catalyst for catalyzing the hydrogen.

33. The appliance of claim 32, wherein the reaction unit comprises the catalytic unit, the catalytic unit including a catalytic combustion chamber in which the catalyst is arranged.

34. The appliance of claim 33, wherein the catalyst is arranged in the catalytic combustion chamber such that the catalyst forms a permeable partition that subdivides the catalytic combustion chamber into two sub-chambers.

35. The appliance of claim 34, wherein the catalyst is permeable and is at least one of: (1) in the form of a lattice; (2) hydrophilic; or (3) made of titanium.

36. The appliance of claim 33, wherein the catalytic combustion chamber has a mixture inlet for an air-hydrogen mixture, and an outlet opening for a catalytically heated air flow.

37. The appliance of claim 36, wherein the mixture inlet is arranged on a first end of the catalytic combustion chamber in a longitudinal direction of the catalytic combustion chamber and the outlet opening is arranged on an opposite, second end of the catalytic combustion chamber.

38. The appliance of claim 32, wherein the reaction unit comprises the catalytic unit, the catalytic unit including an auxiliary heating system for heating and/or drying the catalyst.

39. The appliance of claim 32, wherein the reaction unit comprises the catalytic unit, and wherein the reaction unit includes a temperature sensor.

40. The appliance of claim 32, wherein the reaction unit comprises the catalytic unit, and wherein the reaction unit has a mixing chamber into which the hydrogen and air can be supplied and mixed with one another for form an air-hydrogen mixture, the mixing chamber including an inlet opening for the air, a hydrogen inlet for the hydrogen and a mixture outlet for the air-hydrogen mixture.

41. The appliance of claim 40, wherein the inlet opening is arranged on a first end of the mixing chamber in a longitudinal direction of the mixing chamber, the mixture outlet is arranged on an opposite, second end of the mixing chamber and the hydrogen inlet is arranged between the first and second ends.

42. The appliance of claim 40, wherein the mixing chamber has a first section that tapers from the inlet opening towards the mixture outlet, and a constant-diameter second section and a widening third section, the hydrogen inlet being arranged in the region of the second section.

43. The appliance of claim 40, wherein the reaction unit includes a fan and/or a bypass air opening for supplying air into the mixing chamber via the inlet opening.

44. The appliance of claim 40, wherein the reaction unit includes a sensor for determining a mixing ratio of the air-hydrogen mixture.

45. The appliance of claim 40, further comprising a controller configured to: provide for open-loop and/or closed-loop control of the mixing ratio of the air-hydrogen mixture; and/or control of an auxiliary heating system of the reaction unit.

46. The appliance of claim 45, wherein the reaction unit has a hydrogen valve that is actuatable by the controller and via which a hydrogen inflow into the mixing chamber can be controlled.

47. The appliance of claim 32, wherein the provision unit further comprises a compressor for compressing the generated hydrogen.

48. The appliance of claim 32, wherein the provision unit comprises an electrolyzer for generating hydrogen and a water supply for supplying the electrolyzer with water, wherein the water supply includes a collection device for collecting water and/or a treatment device for treating the water.

49. The appliance of claim 48, wherein the provision unit further comprises at least one accumulator for storing the hydrogen, wherein the accumulator is in the form of a pressure accumulator and/or a metal hydride accumulator.

50. The appliance of claim 49, wherein the at least one accumulator is in the form of a main accumulator and an intermediate accumulator, wherein the intermediate accumulator is configured to store the hydrogen generated by the electrolyzer prior to compression by a compressor of the provision unit and the main accumulator is configured to store the hydrogen that has been compressed by the compressor.

51. The appliance of claim 48, wherein the treatment device has at least one filter for filtering the water, wherein the at least one filter comprises at least one of a reverse osmosis filter, a prefilter, or a filter screen.

52. The appliance of claim 51, wherein the water supply has at least one water tank for storing water, wherein the at least one water tank is in the form of an intermediate tank for storing the collected water and/or in the form of a pure water tank for storing the filtered water.

53. The appliance of claim 48, wherein the water supply includes at least one anti-frost device for avoiding frost damage.

54. The appliance of claim 32, further comprising at least one of a power supply for providing current, an energy accumulator, a current distributor for distributing the current, or a current converter.

55. The appliance of claim 32, further comprising at least one of: a computer unit for controlling an operation of the provision unit and/or the reaction unit; or an operating unit for operating the provision unit and/or the reaction unit.

56. The appliance of claim 32, wherein the appliance is in the form of an autonomously operable grill and/or radiant heater, wherein the provision unit and the reaction unit are arranged in a housing and/or mechanically connected to one another.

57. The appliance of claim 56, wherein the housing has a main body and a roof, wherein the main body and the roof are connected to one another by at least one connecting device.

58. The appliance of claim 57, wherein a photovoltaic cell and/or a collection device are/is arranged on the roof and/or on a rear face of the housing, and/or forms the roof and/or the rear face of the housing.

59. The appliance of claim 32, wherein the appliance is in the form of a grill and includes a grill unit, wherein the reaction unit is arranged at least partially within the grill unit and/or the grill unit is operatively connected to the reaction unit.

60. The appliance of claim 59, wherein the grill unit has at least one grating and at least one deflector element, wherein the at least one deflector element is arranged between the at least one grating and the reaction unit such that food lying on the at least one grating is indirectly heated.

61. A method for operating an appliance for heating food and/or for emitting heat to the surroundings,
providing a source of hydrogen using at least one provision unit; and
generating heat from the provided hydrogen using at least one reaction unit,
wherein:
the reaction unit comprises a catalytic unit such that the hydrogen is generated using at least one catalyst of the catalytic unit.

62. The method of claim 61, further comprising:
switching the appliance to an operating setting in which the hydrogen is consumed by the reaction unit; and
after termination of the operating setting, switching the appliance to a production setting in which the hydrogen is produced using the at least one provision unit.

63. The method of claim 61, wherein the hydrogen is generated from water using an electrolyzer, and wherein the water is collected using a collection device and/or is treated using a treatment device.
